(19) United States
(12) Patent Application Publication
(10) Pub. No.: US 2015/0323731 A1
(43) Pub. Date: Nov. 12, 2015

(54) LIGHTING DEVICE, DISPLAY DEVICE AND TELEVISION DEVICE

(71) Applicant: Sharp Kabushiki Kaisha, Osaka-shi, Osaka (JP)

(72) Inventors: Yoshitake ISHIMOTO, Osaka-shi (JP); Yuki HORIGUCHI, Osaka-shi (JP)

(21) Appl. No.: 14/390,073

(22) PCT Filed: Apr. 24, 2013
(86) PCT No.: PCT/JP2013/062018

§ 371 Date: Oct. 2, 2014

(30) Foreign Application Priority Data
May 31, 2012 (JP) 2012-124181

(51) Int. Cl. F21V 8/00; H04N 5/655

(52) U.S. Cl. CPC G02B 6/0066; G02B 6/0085; H04N 5/655

(57) ABSTRACT

A lighting device 24 includes a light guide plate 20, LEDs 28, an LED board 30, a chassis 22, a heat dissipation member 36, and a restriction member 40. The light guide plate 20 includes a light entrance surface 20a and a light exit surface 20b. The heat dissipation member 36 has a heat dissipation property and includes a bottom portion 36a and a stand-up portion 36b. The bottom portion 36a has a plate-like shape arranged on the bottom plate 22a so as to be parallel to the bottom plate 22a. The LED board 30 is mounted to a plate surface of the stand-up portion 36b such that a longitudinal direction thereof and a longitudinal direction of the stand-up portion 36b are parallel to each other and a dimension of the stand-up portion 36b in the longitudinal direction is larger than a dimension of the LED board 30 in the longitudinal direction. The restriction member 40 has elasticity. The restriction member 40 is arranged in space other than space between the LEDs 28 and the light entrance surface 20a, configured to be in contact with the plate surface of the stand-up portion 36b on which the LED board 30 is mounted and the light entrance surface 20a to maintain a distance between the each LED 28 and the light guide plate 20. The restriction member 40 includes a portion that is in contact with a side surface of the LED board 30 on a short-edge side.

### TECHNICAL FIELD

The present invention relates to a lighting device, a display device, and a television device.

### BACKGROUND ART

Displays in image display devices, such as television devices, are now being shifted from conventional cathode-ray tube displays to thin displays, such as liquid crystal displays and plasma displays. With the thin displays, the thicknesses of the image display devices can be reduced. Liquid crystal panels included in the liquid crystal display devices do not emit light, and thus backlight devices are required as separate lighting devices. An edge light-type backlight device including a light guide plate with a light entrance surface on the side and light sources such as LEDs arranged closer to the side of the light guide plate is known as an example of such backlight devices.

In such a backlight device, the light guide plate may expand or contract due to heat generated around the light sources. When the light guide plate expands or contracts, a distance between the light sources and the light entrance surface of the light guide plate may vary or the light guide plate may vibrate in the plate surface direction thereof. As a result, proper optical properties may not be maintained.

Patent document 1 discloses an edge light-type planar lighting system in which variations in distance between a light guide plate and a light entering surface and vibration of the light guide plate are controlled or reduced. In the planar lighting system, transparent spacers are arranged between light sources and the light entering surface. With the spacers, the distance between the light sources and the light entering surface is regulated. Furthermore, in the planar lighting device, elastic action parts having elastic properties are arranged between side surfaces of the light guide plate except for the side surface opposite the light sources and a chassis. With the elastic action parts, vibration of the light guide plate is absorbed.

### RELATED ART DOCUMENT

### Patent Document

Patent Document 1: Japanese Unexamined Patent Application Publication No. 2008-097877

### Problem to be Solved by the Invention

In the planar lighting system of patent document 1, transparent spacers are arranged between the light sources and the light entering surface of the light guide plate. Rays of light emitted from the light sources toward the light entering surface pass through the spacers. Therefore, luminance efficiency of light entering the light guide plate may decrease. As a result, proper optical properties may not be maintained.

### DISCLOSURE OF THE PRESENT INVENTION

The technology described in this specification was made in view of the foregoing circumstances. An object of the technology described herein is to provide an edge light-type lighting device in which proper optical properties are maintained even if expansion or contraction of a light guide plate occurs.

### Means for Solving the Problem

Technologies described herein are related to a lighting device having the following configurations. The lighting device includes a light guide plate, a light source, alight source board, a chassis, a heat dissipation member, and a restriction member. The light guide plate includes at least one side surface configured as a light entrance surface and a plate surface configured as a light exit surface. The light source is arranged such that a light emitting side thereof is opposite the light entrance surface. The light source board has a rectangular shape and arranged such that a plate surface thereof faces the light entrance surface with a longitudinal direction thereof parallel to a plate surface direction of the light guide plate. The light source is disposed on the plate surface thereof. The chassis includes at least a bottom plate arranged opposite from the light exit surface of the light guide plate and holds at least the light guide plate, the light source, and the light source board therein. The heat dissipation member has a heat dissipation property. The heat dissipation member includes a bottom portion and a stand-up portion. The bottom portion has a plate-like shape arranged on the bottom plate so as to be parallel to the bottom plate. The stand-up portion has a rectangular plate-like shape, projects from a portion of the bottom portion toward the light exit surface. The light source board is mounted to a plate surface of the stand-up portion such that a longitudinal direction thereof and a longitudinal direction of the stand-up portion are parallel to each other and a dimension of the stand-up portion in the longitudinal direction is larger than a dimension of the light source board in the longitudinal direction. The restriction member has elasticity. The restriction member is arranged in space other than space between the light source and the light entrance surface. The restriction member is configured to be in contact with the plate surface of the stand-up portion on which the light source board is mounted and the light entrance surface to maintain a distance between the light source and the light guide plate. The restriction member has a portion that is in contact with a side surface of the light source board on a short-edge side.

According to the above lighting device, the distance between the light source and the light entrance surface of the light guide plate is maintained by the restriction member. Therefore, the distance between the light source and the light guide plate is maintained constant. Furthermore, the restriction member is arranged in the space other than the space between the light source and the light entrance surface. Therefore, light emitted by the light source and traveling toward the light entrance surface is not blocked by the restriction member and thus proper optical properties can be maintained. When the light guide plate expands or contracts, the light guide plate may move in the plate surface direction thereof. Because the restriction member has elasticity, the restriction member elastically deforms according to the movement of the light guide plate created by friction between the light guide plate and the restriction member. With the elastic deformation of the restriction member, the expansion and the contraction of the light guide plate are absorbed. The restriction member elastically deforms along the longitudinal direction of the light source board (the longitudinal direction of the stand-up portion). Therefore, even when the restriction member elastically deforms, the distance between the light source and the light guide plate does not change before and after the movement. Furthermore, when the light guide plate expands or contracts, a strong force may be exerted on the restriction member in the longitudinal direction of the light source board and toward the light source board. Even so, because the portion of the restriction member is in contact with the side surface of the light source board on the short-edge side, the restriction portion is less likely to come out of the space between the stand-up portion and the light entrance surface. With the above configurations, the lighting device can maintain proper optical properties even when expansion or contract of the light guide plate occurs.

The portion of the restriction member may be affixed to the side surface of the light source board on the short-edge side. With this configuration, the restriction member is less likely to come off the side surface of the light source board on the short-edge side. Therefore, the restriction member is less likely to move (position shifting is less likely to occur) even when a strong force is exerted on the restriction member in the longitudinal direction of the light source board and an opposite direction to a direction toward the light source board due to expansion or contract of the light guide plate. As a result, the restriction member is further less likely to come out of the space between the stand-up portion and the light entrance surface.

The restriction member may have a rectangular U-shaped cross section. The restriction member may be arranged to support the stand-up portion from front and back and to be movable in a direction along a plate surface direction of the light guide plate and perpendicular to an arrangement direction of the light source and the light guide plate.

In this configuration, the restriction member holds the stand-up portion from front and back, that is, the restriction member is held to the stand-up portion. In comparison to a configuration in which the restriction member is arranged only on a side of the stand-up portion to which the light source board is mounted, the restriction member is further less likely to come out of the space between the stand-up portion and the light entrance surface. Furthermore, with this configuration, the restriction portion is movable in the longitudinal direction of the light source board while holding the stand-up portion. Even when a strong force is exerted on the restriction member in the longitudinal direction of the light source board and the opposite direction to the direction toward the light source board according to the movement of the light guide plate in the longitudinal direction thereof due to expansion or contraction thereof, the restriction member moves according to the movement of the light guide plate. With this configuration, the expansion and the contraction of the light guide plate are absorbed.

The restriction member may include an engagement projection that projects from a portion opposite the plate surface of the stand-up portion toward the stand-up portion. The stand-up portion may include an engagement hole in a portion opposite the engagement projection. The engagement hole may be configured to receive the engagement projection and have an oval shape with a major axis along the longitudinal direction of the stand-up portion.

With this configuration, movement of the engagement hole of the restriction portion having the oval shape in the minor-axis direction is restricted with the engagement projection fitted in the engagement hole. Therefore, the restriction member is further less likely to come off the stand-up portion. If the restriction member is movable away from the light source board, the restriction portion is movable in the major-axis direction of the engagement hole (the longitudinal direction of the stand-up portion) because the engagement hole has the oval shape.

The lighting device may further include a screw. The stand-up portion may include a through hole that extends from one plate surface to another and have an oval shape with a major axis along the longitudinal direction of the stand-up portion. The screw may be passed through at least one of portions of the restriction member arranged on a front surface side and a back surface side of the stand-up portion and through the through hole.

With this configuration, the movement of the through hole of the restriction portion having the oval shape with the screw passed through the portion of the restriction member and the through hole. Therefore, the restriction member is further less likely to come off the stand-up portion. If the restriction member is movable away from the light source board, the restriction member is movable in the major-axis direction of the through hole (the longitudinal direction of the stand-up portion) because the through hole has the oval shape.

The distance between the light source and the light entrance surface may be within a range from 0.3 mm to 0.5 mm.

With this configuration, a decrease in intensity of light exiting from the light guide plate through the light exit surface due to an increase in distance between the light source and the light guide plate is less likely to occur.

The restriction member may include a pair of restriction members arranged so as to be in contact with side surfaces of the light source board on short-edge sides, respectively.

With this configuration, the distance between the light guide plate and the light source is effectively maintained with two restriction members.

The technologies described in this specification may be applied to a display device including a display panel configured to provide display using light from the above-described lighting device. A display device that includes a liquid crystal panel as such a display panel may be considered as new and advantageous. Furthermore, a television device including the above-described display device may be considered as new and advantageous. In the above-described display device or the above-described television device, a display area can be increased.

### Advantageous Effect of the Invention

According to the technologies described in this specification, an edge-light-type lighting device in which proper optical properties are maintained even when expansion or contraction of the light guide plate occurs is provided.

### BRIEF DESCRIPTION OF THE DRAWINGS

FIG. 1 is an exploded perspective view of a television device TV according to a first embodiment.

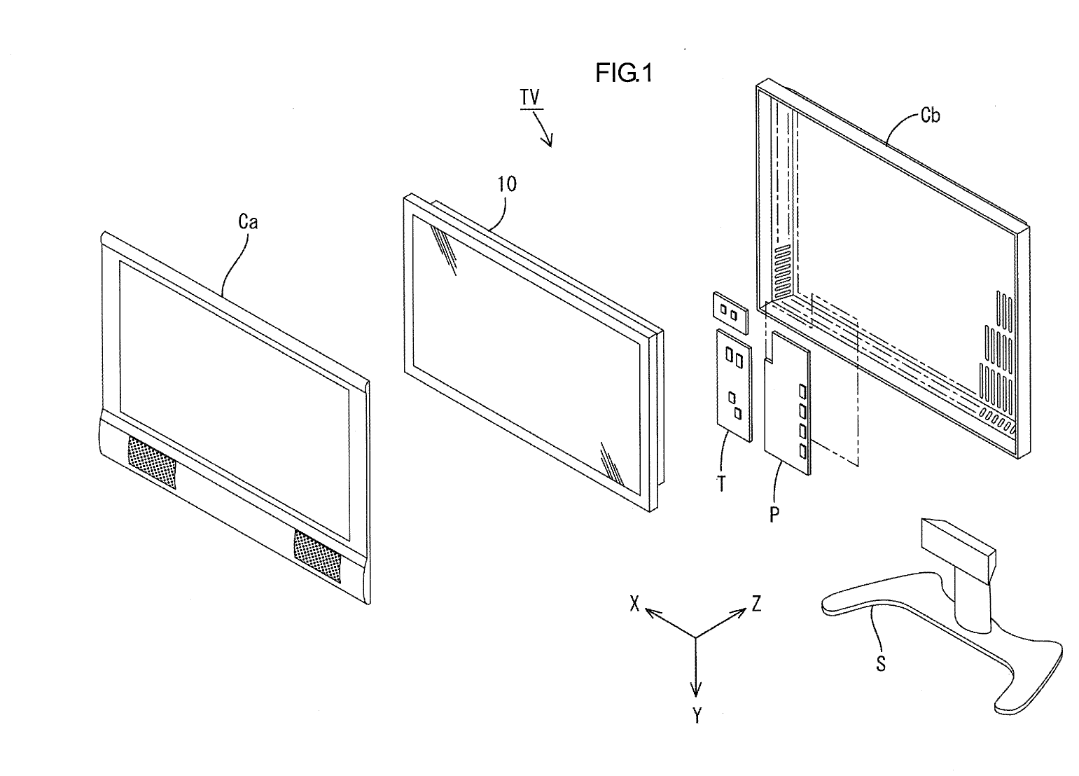

FIG. 2 is an exploded perspective view of a liquid crystal display device 10.

FIG. 3 is a cross-sectional view of the liquid crystal display device 10 along a plane that crosses a restriction member 40.

FIG. 4 is a cross-sectional view of the liquid crystal display device 10 along a plane that crosses an LED board 30.

FIG. 5 is a cross-sectional view of a relevant portion of the liquid crystal display device 10.

FIG. 6 is a front view of a back light unit 24.

FIG. 7 is a magnified front view of a relevant portion of FIG. 6.

FIG. 8 is a cross-sectional view of a liquid crystal display device 110 according to a second embodiment.

FIG. 9 is a magnified front view of a relevant portion of a back light unit 124.

FIG. 10 is a perspective view of a restriction member 140.

FIG. 11 is a cross-sectional view of a relevant portion of a liquid crystal display device 210 according to a third embodiment.

FIG. 12 is a front view of a heat dissipation member 236 with an LED board 230 and restriction members 240 mounted thereto.

FIG. 13 is a front view of a heat dissipation member 336 with an LED board 330 and restriction members 340 mounted thereto according to a fourth embodiment.

FIG. 14 is a magnified front view of a relevant portion of a back light unit 324.

FIG. 15 is a cross-sectional view of a liquid crystal display device 410 according to a fifth embodiment.

### MODE FOR CARRYING OUT THE INVENTION

A first embodiment will be described with reference to the drawings. X-axes, Y-axes and Z-axes are provided in portions of the drawings, respectively. The axes in each drawing correspond to the respective axes in other drawings. The X-axes and Y-axes are aligned with the horizontal direction and the vertical direction, respectively. In the following description, the top-bottom direction corresponds to the vertical direction unless otherwise specified.

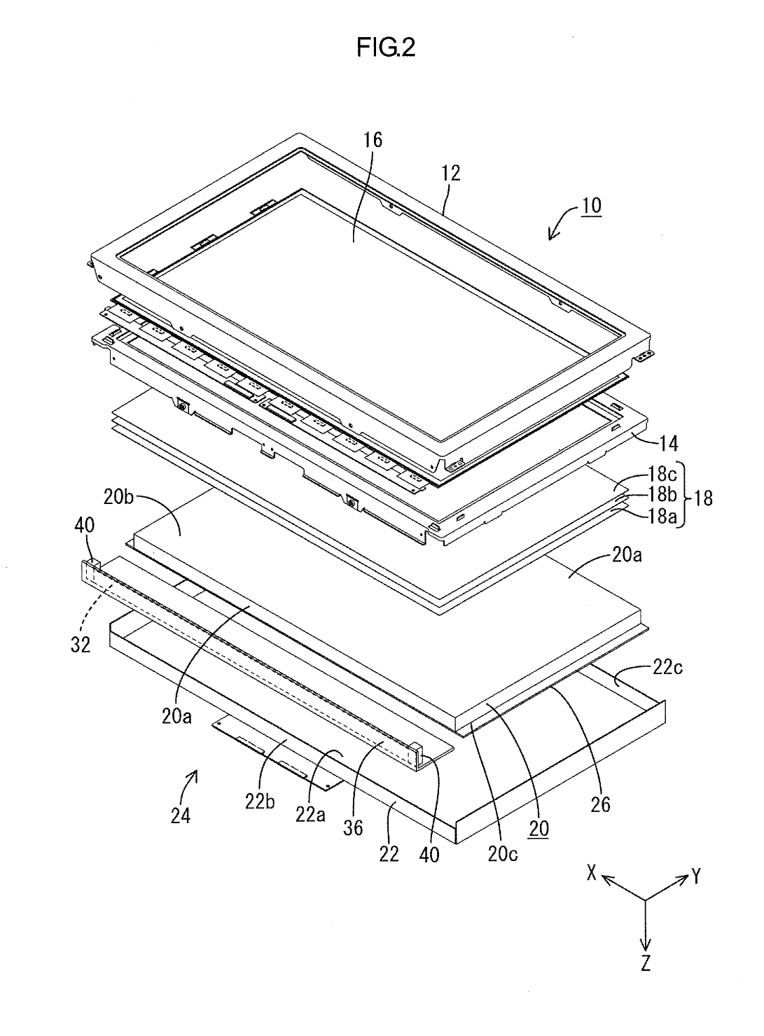

A television device TV includes the liquid crystal display device (an example of a display device) 10, front and rear cabinets Ca, Cb that hold the liquid crystal display device 10 therebetween, a power source P, a tuner T, and a stand S. In FIG. 2, the upper side and the lower side correspond to the front side and the rear side of the liquid crystal display device 10, respectively. As illustrated in FIG. 2, an overall shape of the liquid crystal display device 10 is a landscape rectangular. The liquid crystal display device 10 includes a liquid crystal panel 16 and a backlight unit (an example of a lighting device) 24. The liquid crystal panel 16 is a display panel and the backlight unit 24 is an external light source. The liquid crystal panel 16 and the backlight unit 24 are integrally held with a bezel 12 having a frame-like shape.

Next, the liquid crystal panel 16 will be described. The liquid crystal panel 16 includes a pair of transparent glass substrates (having a high light transmission capability) and a liquid crystal layer (not illustrated). The glass substrates are bonded together with a predetermined gap therebetween. The liquid crystal layer is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, counter electrodes and an alignment film are provided. Image data and various control signals are transmitted from a driver circuit board (not illustrated) to the source lines, the gate lines, and the counter electrodes for displaying images. Polarizing plates (not illustrated) are attached to outer surfaces of the glass substrates.

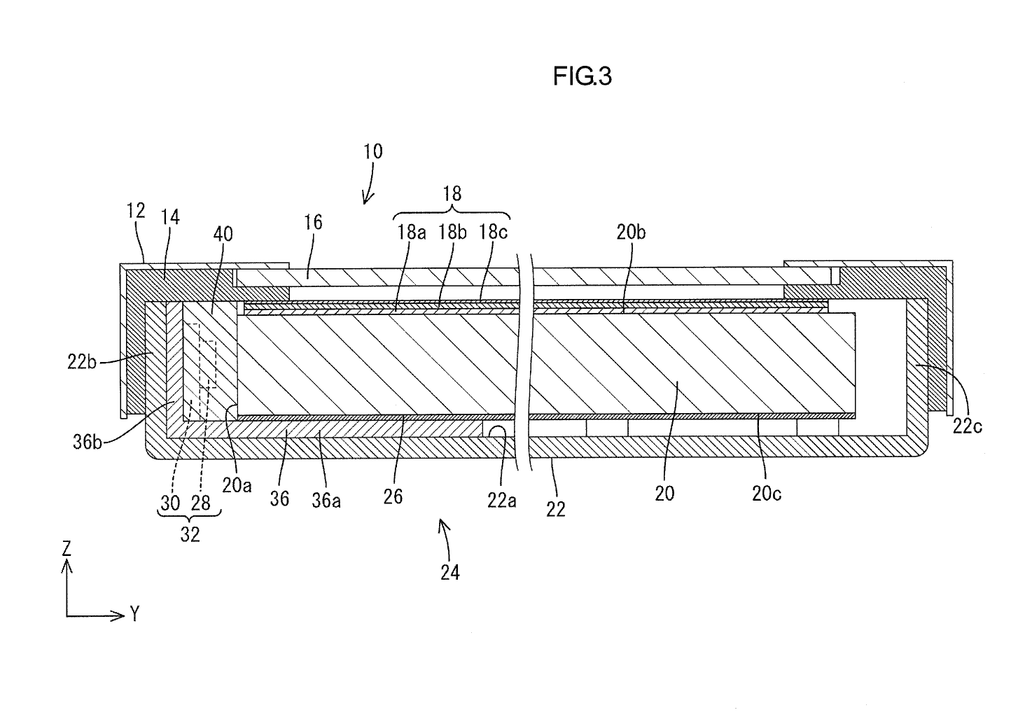

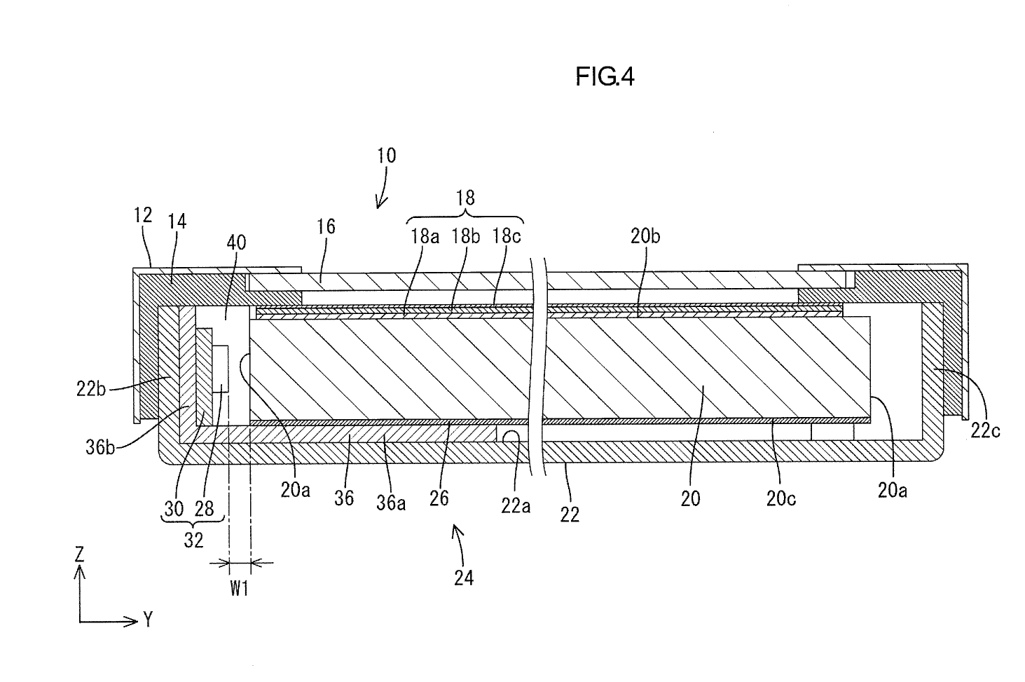

Next, the backlight unit 24 will be described. FIG. 3 is a cross-sectional view of the liquid crystal display device 10 cut along the vertical direction (the Y-axis direction) crossing a restriction member 40, which will be described later. FIG. 4 is a cross-sectional view of the liquid crystal display device 10 cut along the vertical direction (the Y-axis direction) crossing an LED board 28, which will be described later. As illustrated FIGS. 2 through 4, the backlight unit 24 includes an optical member 18, a frame 14, a chassis 22, a heat dissipation member 36, and restriction members 40. The frame 14 has a frame shape and is arranged along edges of a surface of the light guide plate 20 (a light entrance surface 20b). The frame 14 holds the liquid crystal panel 16 at the inner edges thereof. The optical member 18 is placed on a light exit surface 20b on the front side of a light guide plate 20. Space is provided between the liquid crystal panel 16 and the optical member 18 with a portion of the frame 14 arranged therebetween.

LED (light emitting diode) unit 32, a reflection sheet 26, the light guide plate 20, the heat dissipation member 36, and the restriction members 40 are held in the chassis 22. The heat dissipation member 36 extends along the longitudinal direction of the chassis 22 (the X-axis direction) and has an L-like cross section. The LED unit 32 is arranged along the longitudinal direction of the chassis 22 and in contact with an inner surface of the heat dissipation member 36. The LED unit 32 is configured to emit light toward the light entrance surface 20a of the light guide plate 20. The light guide plate 20 is arranged such that one of long side surfaces (the light entrance surface) 20a is opposite the respective LED unit 32. The light emitted by the LED unit 32 is guided toward the liquid crystal panel 16. The optical member 18 is placed on the front surface of the light guide plate 20. In the backlight unit 24 of this embodiment, the light guide plate 20 and the optical member 18 are arranged immediately below the liquid crystal panel 16. In the backlight unit 24 according to this embodiment, the LED unit 32, behind which the light guide plate 20 and the optical member 18 are arranged and which are a light source, are arranged at the side edges of the light guide plate 20. Namely, an edge lighting method (a side lighting method) is adapted to the backlight unit 24.

The chassis 22 is made of metal, for instance, aluminum-based material. The chassis 22 includes a bottom plate 22a, side plates 22b, 22c that upstand from the respective long edges of the bottom plate 22a, and side plates that upstand from the respective short edges of the bottom plate 22a. In the chassis 22, space between the LED unit 32 and the side plate 22c is holding space for the light guide plate 20. A power supply circuit board for supplying power to the LED unit 32 is mounted to the back surface of the bottom plate 22a (not illustrated).

The optical member 18 has a rectangular plan-view shape. The optical member 18 includes a diffuser sheet 18a, a lens sheet 18b, and a reflection-type polarizing plate 18c layered in this sequence from the light guide plate 20 side. The diffuser sheet 18a, the lens sheet 18b, and the reflection-type polarizing plate 18c have a function to convert the light emitted by the LED unit 32 and passed through the light guide plate 20 into planar light. The liquid crystal panel 16 is arranged over and spaced away from the upper surface of the reflection-type polarizing plate 18d. As illustrated in FIG. 3, the optical member 18 is arranged such that ends thereof with respect to the short-side direction are located inner (closer to the middle of the chassis 22) than the light entrance surface 20a.

The LED unit 32 includes an LED board 30 and LEDs 28. The LED board 30 is rectangular and made of resin. The LEDs 28 configured to emit white light are arranged in line on the LED board 30. A surface of the LED board 30 on which the LEDs 28 are disposed (hereinafter referred to as a mounting surface 30a) has light reflectivity. The LED board 30 is arranged such that a surface thereof opposite from the mounting surface 30a is in contact with the heat dissipation member 36. Each LED 28 may be configured one of the followings. The LED 28 may include a blue light emitting element with a phosphor having a light emission peak in a yellow region applied on the blue light emitting element to emit white light. The LED 28 may include a blue light emitting element with a phosphor having a light emission peak in a green region and a phosphor having a light emission peak in a red region applied on the blue light emitting element to emit white light. The LED 28 may include a blue light emitting element with a phosphor having a light emission peak in a green region applied on the blue light emitting element, and a red light emitting element to emit white light. The LED 28 may include an ultraviolet light emitting element and a phosphor. The LED 28 may include an ultraviolet light emitting element with phosphors having light emissions peaks in the blue region, the green region, and the red region, respectively, applied on the ultraviolet light emitting element.

The light guide plate 20 is a rectangular plate made of resin having a high light transmission capability (high transparency), such as acrylic. The light guide plate 20 is in contact with the reflection sheet 26 and held over a bottom portion 36a of the heat dissipation member 36 spaced from the bottom plate 22a of the chassis 22. As illustrated in FIGS. 2 through 4, the light guide plate 20 is arranged between the LED unit 32 and the side plate 22c such that the light exit surface 20, which is a main plate surface, faces the diffuser sheet 18a and the opposite plate surface 20c, which is opposite from the light exit surface 20b, faces the light reflection sheet 26. Because the light guide plate 20 is arranged as described above, the light emitted by the LED unit 32 enters the light guide plate 20 through the light entrance surface 20a and exits therefrom through the light exit surface 20b that faces the diffuser sheet 18a. The liquid crystal panel 16 is illuminated with the light from the back.

The reflection sheet 26 is rectangular and made of synthetic resin with a white surface having a high light reflectivity. The reflection sheet 26 is arranged so as to be in contact with the opposite plate surface 20c of the light guide plate 20 and spaced from the bottom plate 22a of the chassis 22. The reflection sheet 26 has a reflection surface on the front side thereof. The reflection surface is in contact with the opposite surface 20c of the light guide plate 20. The reflection sheet 26 is configured to reflect leaking light from the LED unit 32 or the light guide plate 20 toward the opposite surface.

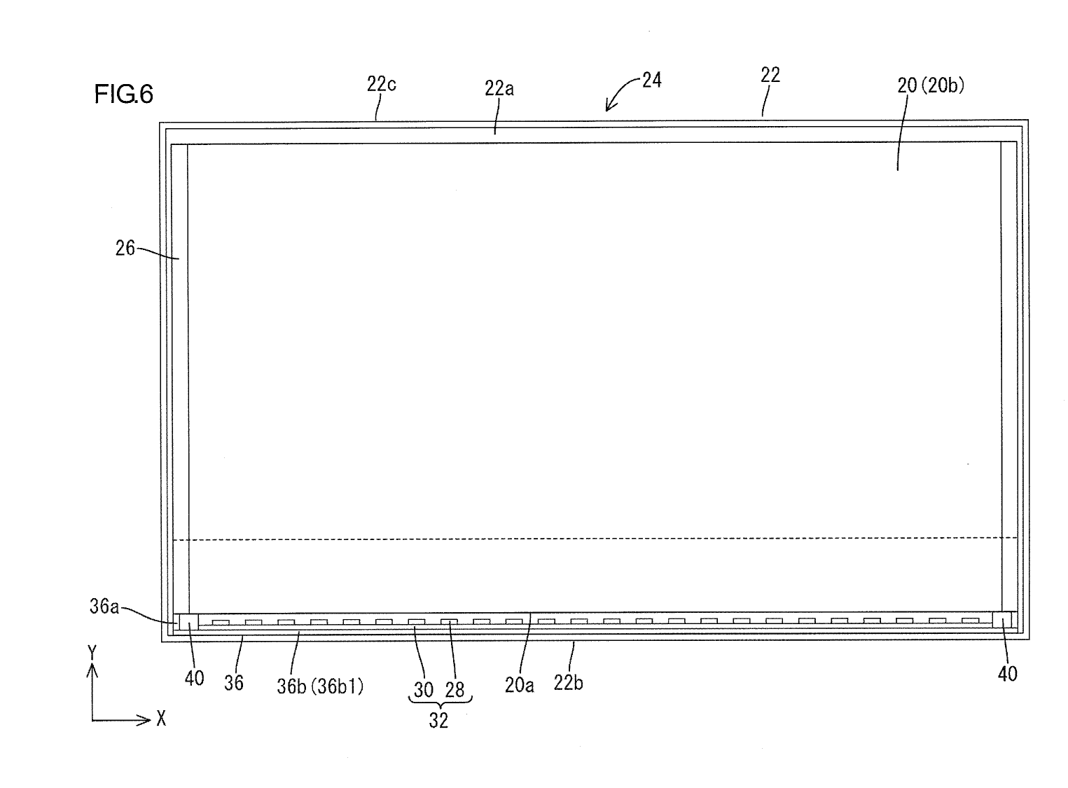

The heat dissipation member 36 is a plate-shaped member having higher heat dissipation properties than the LED board 30 having the L-shaped cross section. The heat dissipation member 36 is arranged along the longitudinal direction of the chassis 22 (the X-axis direction). The heat dissipation member 36 includes the bottom portion 36a and a stand-up portion 36b (see FIG. 4). The bottom portion 36a has a rectangular plan view shape (see FIG. 2) and extends from the side plate 22b side toward the middle portion of the light guide plate 20 along the bottom plate 22a of the chassis 22. The bottom portion 36a is in contact with the bottom plate 22a of the chassis 22. An end of the bottom portion 36a on the side plate 22b side is in contact with the side plate 22b of the chassis 22. The stand-up portion 36b is a plate that rises from an edge of the bottom portion 36a in contact with the side plate 22b of the chassis 22. The stand-up portion 36b projects upright relative to the bottom plate 22a of the chassis 22. The inner surface of the stand-up portion 36b (a surface that faces the light guide plate 20) is in contact with a plate surface of the LED board 30 opposite from the mounting surface 30a. The outer surface of the stand-up portion 36b (an opposite surface from the surface that faces the light guide plate 20) is in contact with the side plate 22b of the chassis 22. As illustrated in FIG. 6, a dimension of the heat dissipation member 36 in the longitudinal direction (the X-axis direction) is larger than a dimension of the LED board 30 in the longitudinal direction (the X-axis direction). The heat dissipation member 36 is arranged such that ends thereof with respect to the longitudinal direction are located outer than the ends of the LED board 30 with respect to the longitudinal direction (portions outer than the ends of the LED board 30 are hereinafter referred to as outer portions).

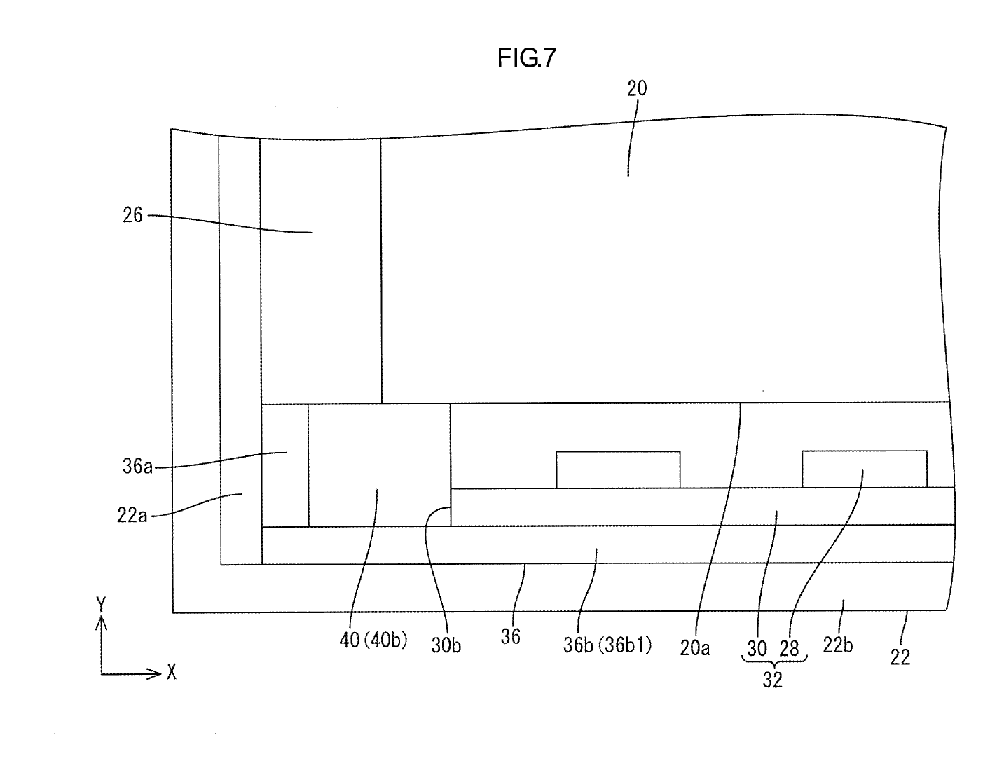

Next, a configuration, an arrangement, and an effect of the restriction members 40, which are major components of this embodiment, will be described. Each of the restriction members 40 is an elastic member such as a rubber. The restriction member 40 has a longitudinal block-like shape (a longitudinal dimension in the thickness direction of the light guide plate 20 (the Z-axis direction)). The restriction members 40 are arranged on the outer portions of the heat dissipation member 36, that is, at the ends of the stand-up portion 36b with respect to the longitudinal direction (the X-axis direction), respectively (see FIG. 6). The restriction members 40 are arranged between the stand-up portion 36b of the heat dissipation member 36 and the light entrance surface 20a of the light guide plate 20 (specifically, at the respective ends of the light entrance surface 20 with respect to the longitudinal direction (the X-axis direction). More specifically, the front surface (the surface that faces the light guide plate 20) 40a of each restriction member 40 is in contact with the light entrance surface 20a. The back surface (the surface that faces the side wall 22b of the chassis 22) 40b of each restriction member 40 is in contact with the plate surface of the stand-up portion 36b. One of the side surfaces (an inner surface, a side surface that faces toward the LED board 30) is in contact with the side surface 30b of the LED board 20 on the short side (see FIG. 7). The restriction member 40 is within space between the frame 14 and the bottom portion 36a of the heat dissipation member 36. The upper surface and the lower surface of the restriction member 40 are close to the frame 14 and the bottom portion 36a of the heat dissipation member 36, respectively.

As described above, the restriction members 40 are in contact with the stand-up portion 36b of the heat dissipation member 36 and the light entrance surface 20a of the light guide plate 20. Therefore, a distance W1 between each LED 28 and the light entrance surface 20a (see FIG. 4) is maintained within a limit. In this embodiment, the distance W1 between the LED 28 and the light entrance surface 20a is maintained in a range from 0.3 mm to 0.5 mm. Furthermore, the restriction members 40 are arranged on the outer portions, that is, the restriction members 40 are not arranged between the LED 28 and the light entrance surface 20a. The light emitted by the LED 28 and traveling toward the light entrance surface 20a is less likely to be blocked by the restriction member 40.

Each restriction member 40 is in contact with the plate surface of the stand-up portion 36b and the light entrance surface 20a, that is, the restriction member 40 is sandwiched therebetween. When the light guide plate 20 moves in the plate surface direction (along the X-Y plane), friction is created between the light guide plate 20 and the restriction member 40. A force induced by the movement of the light guide plate 20 is exerted on the restriction member 40. When the force is exerted on the restriction member 40, the restriction member 40 elastically deforms according to the movement of the light guide plate 20. With this configuration, expansion and contraction of the light guide plate are absorbed. Because the distance between the stand-up portion 36b and the light entrance surface 20a is maintained within the limit, the distance between the LED 28 and the light entrance surface 20a does not change even when the elastic deformation of the restriction member 40 occurs. Therefore, proper optical properties are maintained. Even if the strong force is exerted on the restriction member 40 in the longitudinal direction of the LED board 30 and toward the LED board 30 (one of the directions along the X-axis direction) according to the movement of the light guide plate 20, the restriction member 40 does not move along the plate surface of the stand-up portion 36b (position shifting does not occur). This is because the restriction member 40 is in contact with the side surface 30b on the short side of the LED board 30. With this configuration, when the strong force is exerted on the restriction member 40, the restriction member 40 does not move or is less likely to move out of the stand-up portion 36b and come off.

As described above, a pair of the restriction members 40, 40 is arranged on the stand-up portion 36b of the heat dissipation member 36 and in contact with the plate surface of the stand-up portion 36b and the light entrance surface 20a. With this configuration, the distance W1 between each LED 28 and the light entrance surface 20a is maintained within the limit. Even when the light guide plate 20 moves in the short-side direction of the light guide plate 20 (the Y-axis direction) along the plate-surface direction thereof due to vibration or expansion, the distance between the LED 28 and the light entrance surface 20a does not move or is less likely to move. Therefore, the proper optical properties are maintained. If the light guide plate 20 moves in the long-side direction of the stand-up portion 36b (the X-axis direction) due to vibration or expansion, the restriction member 40 elastically deforms according to the movement of the light guide plate 20. As a result, the movement of the light guide plate 20 is absorbed. In the backlight unit 24, because of the restriction members 40, the movement of the light guide plate 20 is absorbed while the proper optical properties are maintained even when the light guide plate 20 moves in the plate surface direction thereof due to vibration, expansion, or contraction.

As described above, in the backlight unit 24 of this embodiment, the distance between each LED 28 and the light entrance surface 20a of the light guide plate 20 is maintained within the limit by the restriction members 40. Therefore, the distance between the LED 28 and the light guide plate 20 is maintained constant. Furthermore, the restriction members 40 are arranged in portions other than between the LEDs 28 and the light entrance surface 20a. Therefore, the light emitted by the LEDs 28 and traveling toward the light entrance surface 20a is not blocked by the restriction members 40 and thus proper optical properties can be maintained. Because the restriction members 40 have the elasticity, the restriction members 40 elastically deform according to the movement of the light guide plate 20 due to the friction between the light guide plate 20 and the restriction members 40 when the light guide plate 20 moves in the plate-surface direction due to expansion or contraction. With the elastic deformation of the restriction members 40, the expansion and the contraction of the light guide plate 20 are absorbed. The restriction members 40 elastically deform or move along the longitudinal direction of the LED board 30 (the longitudinal direction of the stand-up portion 36b, the X-axis direction). Therefore, even when the restriction members 40 elastically deform, the distance between the LED 28 and the light guide plate 20 does not change before and after the movement. Furthermore, because the restriction members 40 are in contact with the side surfaces of the LED board 30 on the short sides thereof in portions, even when the strong force is exerted on the restriction member 40 in the longitudinal direction of the LED board 30 and toward the LED board 30 due to the expansion or the contraction of the light guide plate 20, the restriction member 40 does not move or is less likely to move out of the space between the stand-up portion 36b and the light entrance surface 20a. Therefore, in the backlight unit 24 according to this embodiment, the proper optical properties are maintained even when expansion or contract of the light guide plate 20 occurs.

In the backlight unit 24 according to this embodiment, the distance W1 between each LED 28 and the light entrance surface 20a of the light guide plate 20 is maintained within the range from 0.3 mm to 0.5 mm. Therefore, a decrease in intensity of light exiting from the light guide plate 20 through the light exit surface 20b due to an increase in distance W1 between the LED 28 and the light guide plate 20 is less likely to occur.

The backlight unit 24 according to this embodiment includes a pair of the restriction members 40, 40 arranged so as to be in contact with the side surfaces 30b of the LED board 30 on the short sides thereof, respectively. With this configuration, the distance between the light guide plate 20 and each LED 28 can be effectively maintained by the restriction members 40.

### Modifications of the First Embodiment

Next, a Modification of the First Embodiment Will be described. In the modification, portions of the restriction members 40 in contact with the side surfaces 30b of the LED board 30 on the short sides thereof are affixed to the side surfaces 30b with adhesive tapes. With this configuration, the restriction members 40 are less likely to move away from the side surfaces 30b. Even when strong forces are exerted on the restriction members 40 in the longitudinal direction of the LED board 30 (the X-axis direction) opposite to a direction toward the LED board 30 (a direction away from the LED board 30), the restriction members 40 are less likely to move (position shifting is less likely to occur). In this embodiment, the restriction members 40 are further less likely to come out of the space between the stand-up portion 36b and the light entrance surface 20a.

### Second Embodiment

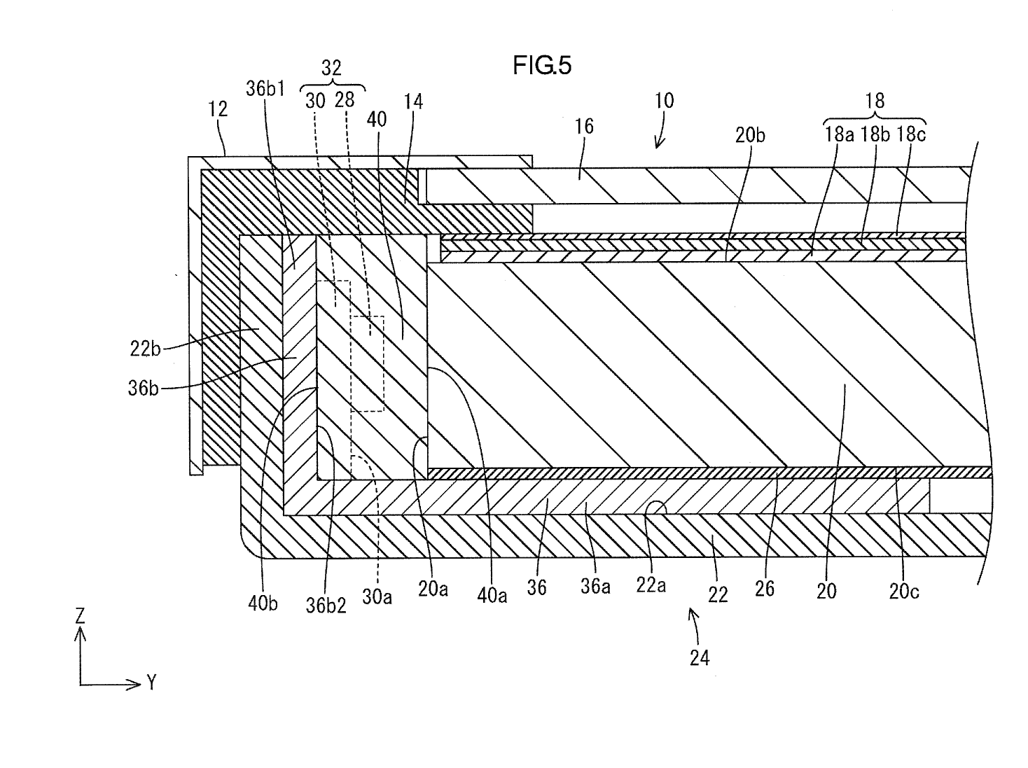

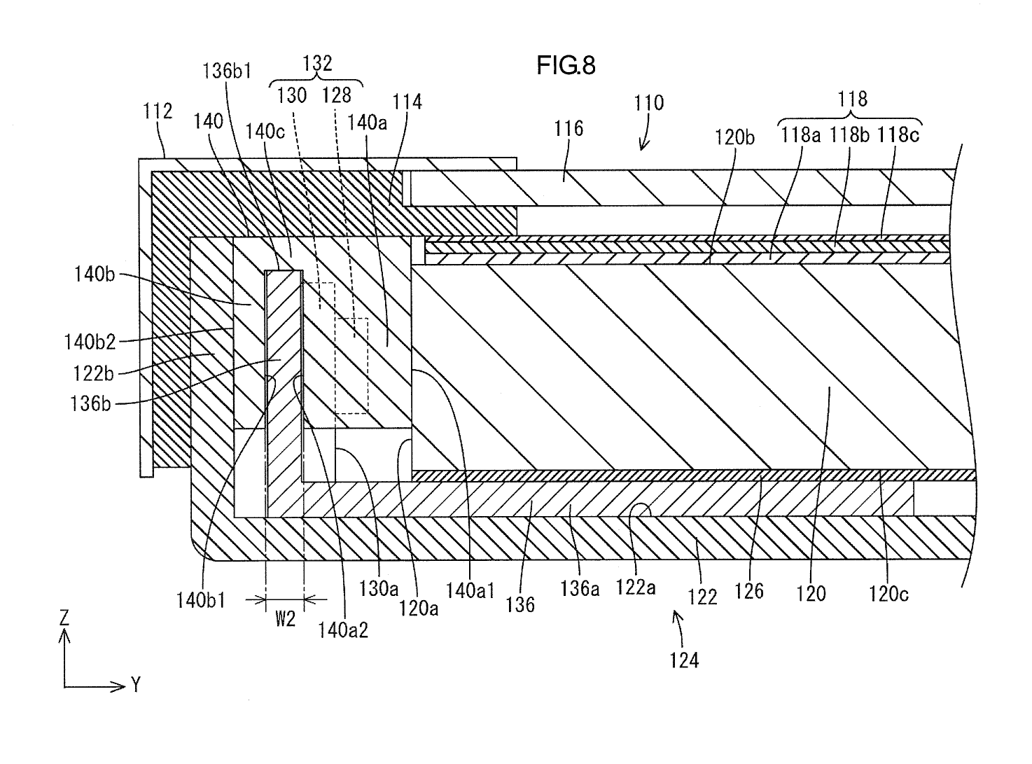

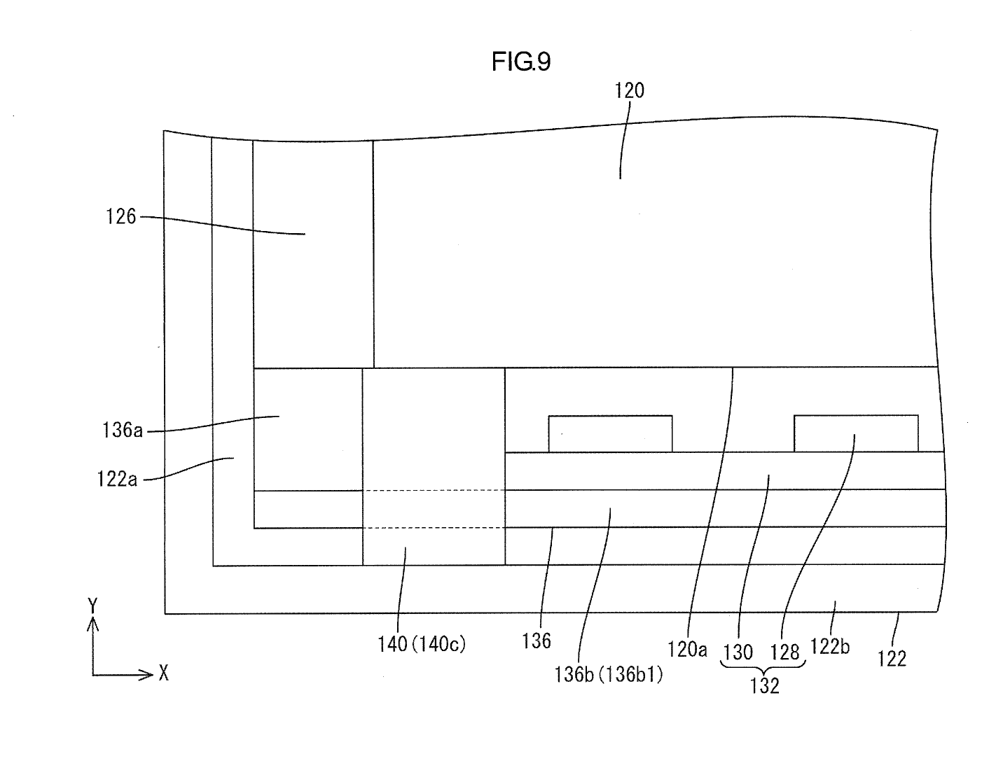

A second embodiment will described with reference to the drawings. The second embodiment includes restriction members 140 formed in a different shape and arranged differently from the first embodiment. Other configurations are the same as the first embodiment and thus configurations, functions, and effects of those will not be described. In FIGS. 8 and 9, portions indicated by numerals including the reference numerals in FIGS. 5 and 7 with 100 added thereto have the same configurations as the portions indicated by the respective reference numerals in the first embodiment.

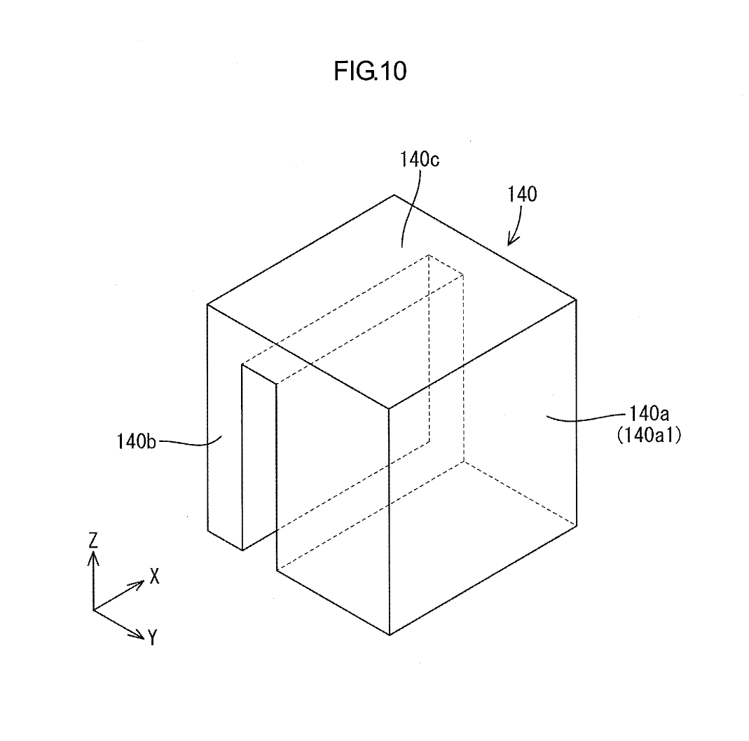

In a backlight unit 124 according to the second embodiment, as illustrated in FIG. 10, each of the restriction members 140 has a block-like shape with a recessed portion. The recessed portion has a rectangular U-shaped cross section and side view with an opening at the bottom thereof. Specifically, each restriction member 140 includes a first side wall 140a, a second side wall 140b, and an upper wall 140c. The first side wall 140a and the second side wall 140b correspond to side walls of the recessed portion. The upper wall 140 connects the first side wall 140a to the second side wall 140b and corresponds to a bottom surface of the recessed portion. The first side wall 140a and the second side wall 140b extend downward perpendicular to the upper wall 140. Namely, the first side wall 140a and the second side wall 140b are parallel to each other. A distance W2 between the first side wall 140a and the second side wall 140b (see FIG. 8) is slightly larger than the thickness of the LED board 130.

As illustrated in FIGS. 8 and 9, each restriction member 140 is arranged such that the first side wall 140a, the second side wall 140b, and the upper wall 140c are positioned as follows. The first side wall 140a is between a stand-up portion 136b of a heat dissipation member 136 and a light entrance surface 120a of the light guide plate 120 (specifically, between ends of the light entrance surface 120a with respect to the longitudinal direction thereof (the X-axis direction)). The second side wall 140b is between the stand-up portion 136b of the heat dissipation member 136 and a side wall 122b of a chassis 122 (specifically, between ends of the side wall 122b with respect to the longitudinal direction thereof (the X-axis direction)). The upper wall 140c is between a distal end surface 136b1 of the stand-up portion 136b of the heat dissipation member 136 and a frame 114. The restriction member 140 is arranged such that the stand-up portion 136b is held in the recessed portion so as to be supported from front and back. Namely, as illustrated in FIG. 5, the stand-up portion 136b is held between the first side wall 140a and the second side wall 140b with the upper wall 140c being in contact with the distal end surface 136b1 of the stand-up portion 136b.

The distance W2 between the first side wall 140a and the second side wall 140b is slightly larger than the thickness of the stand-up portion 136. When the stand-up portion 136 is held between the first side wall 140a and the second side wall 140b, small gaps are provided between the stand-up portion 136 and the first side wall 140a and between the stand-up portion 136 and the second side wall 140b. An inner side surface of the first side wall 140a of the restriction member 140 is in contact with a side surface of the LED board 130 on the short edge thereof. The inner side surface is not affixed to the side surface of the LED board 130 on the short edge with an adhesive. Therefore, the restriction member 140 that holds the stand-up portion 136 is movable along the longitudinal direction of the LED board 130 (the X-axis direction).

The thickness of the first side wall 140a (measuring in the Y-axis direction) is substantially equal to a distance between the stand-up portion 136b and the light entrance surface 120a. A front surface 140a1 of the first side wall 140a (a surface that faces the light guide plate 120) is in contact with the light entrance surface 120a. A back surface 140a2 of the first side wall 140a (a surface opposite the second side wall 140b) is close to the plate surface of the stand-up portion 136b. When the light guide plate 120 expands toward the heat dissipation member 136 (toward the LED 128), the first side wall 140a is pushed toward the stand-up portion 136b and the back surface 140a2 of the first side wall 140a is brought into contact with the plate surface of the stand-up portion 136b. As a result, the first side wall 140a is in contact with the plate surface of the stand-up portion 136b and the light entrance surface 120a. The distance between the stand-up portion 136b and the light entrance surface 120a is maintained by the first side wall 140a. Because the distance between the stand-up portion 136b and the light entrance surface 120a is maintained, the distance W1 between each LED 128 and the light entrance surface 120a (see FIG. 4) is also maintained.

As described above, each restriction member 140 according to this embodiment supports the stand-up portion 136b of the heat dissipation plate 136 from front and back, that is, the restriction member 140 is held to the stand-up portion 136b. In comparison to a configuration in which the restriction member 140 is arranged only on a surface of the stand-up portion 136b on which the LED board 130 is mounted (the configuration of the first embodiment), the restriction member 140 is further less likely to come out of the space between the stand-up portion 136b and the light entrance surface 120a. When the light guide plate 120 expands or contract and moves in the plate surface direction thereof, a strong force may be exerted on the restriction members 140 in the longitudinal direction of the LED board 130 (the X-axis direction) and the opposite direction to the direction toward the LED board 130 (the direction away from the LED board 130). Even so, because the restriction members are movable along the longitudinal direction of the LED board 130 (the X-axis direction) and the restriction members 140 move along with the movement of the light guide plate 120, the expansion and the contraction of the light guide plate 120 are absorbed.

### Third Embodiment

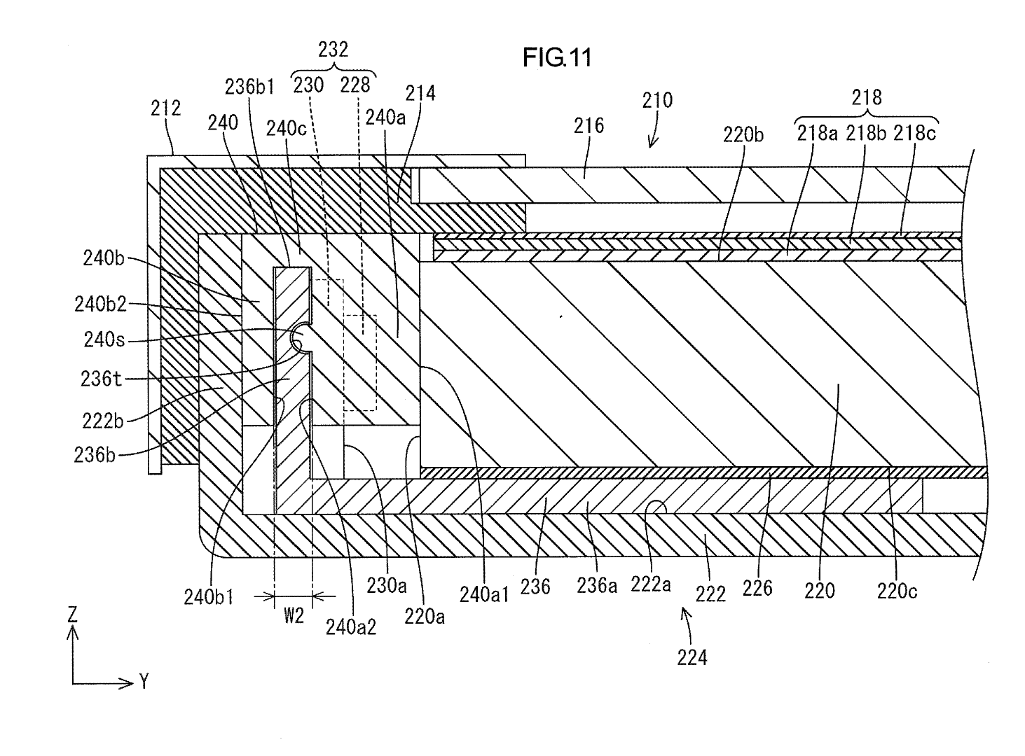

A third embodiment will be described with reference to the drawings. The third embodiment includes holding members 240 having projections 240s. This configuration is different from the second embodiment. Other configurations are the same as the second embodiment and thus configurations, functions, and effects of those will not be described. In FIG. 11, portions indicated by numerals including the reference numerals in FIG. 5 with 100 added thereto have the same configurations as the portions indicated by the respective reference numerals in the second embodiment.

In a liquid crystal display device 210 according to the third embodiment, as illustrated in FIG. 11, each restriction member 240 includes an engagement projection 240s projecting from a back surface 240a2 of a first side wall 240a of the restriction portion 240 (a portion opposite a plate surface of a stand-up portion 236b) toward the stand-up portion 236b. The engagement projection 240s has a length such that it does not pass all the way through the stand-up portion in the thickness direction (the Y-axis direction). The stand-up portion 236 includes an engagement hole 236t in a portion opposite the engagement projection 240s. The engagement hole 236t has a suitable size to receive the engagement projection 240s. As illustrated in FIG. 11, the engagement hole 236t has an oval shape with a major axis along the longitudinal direction of the stand-up portion 236b (the longitudinal direction of the LED board 230, the X-axis direction). With this configuration, when the engagement projection 240s is fitted in the engagement hole 236t, movement of the restriction member 240 in the minor-axis direction of the engagement hole 236t (the Z-axis direction) is restricted. When the light guide plate 220 expands or contracts, the light guide plate 220 may move in the thickness direction thereof (the Z-axis direction). In this case, a force may be exerted on the restriction member 240 in that direction. Even so, the restriction member 240 is less likely to move (position shifting is less likely to occur). Therefore, the restriction member 240 is further less likely to come off the stand-up portion 236b. Even in such a case, the configuration allows the movement of the restriction member 240 in the major-axis direction of the engagement hole 236t (the X-axis direction) because the engagement hole 236t has the oval shape. In this embodiment, the restriction member 240 is further less likely to come off the stand-up portion 236b and proper optical properties are maintained even when expansion or contract of the light guide plate 220 occurs.

### Modification of Third Embodiment

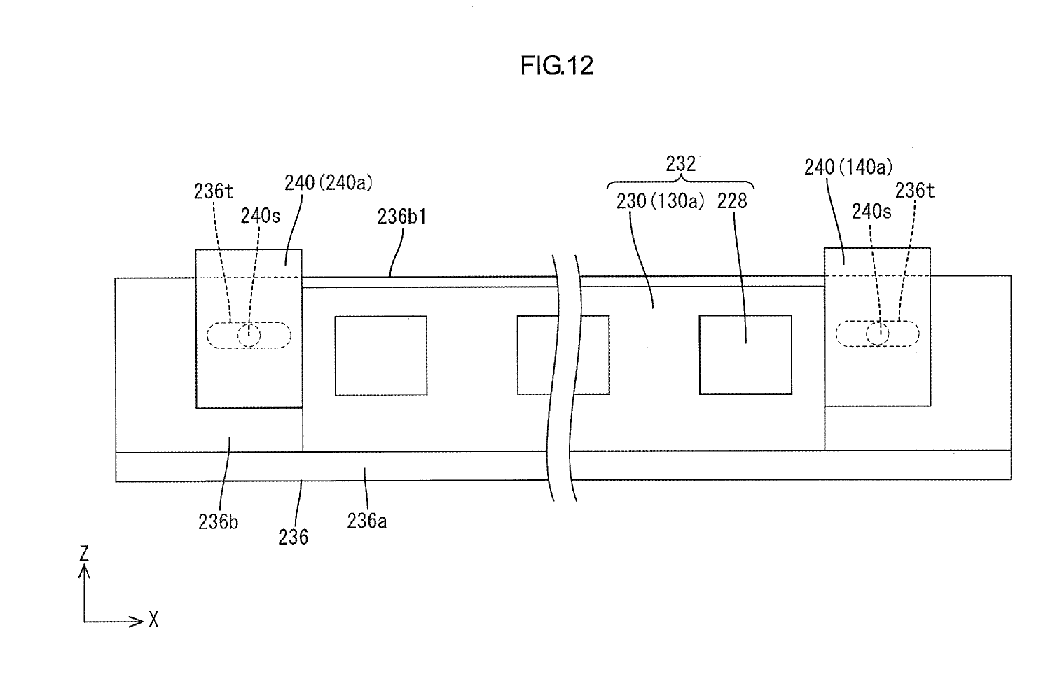

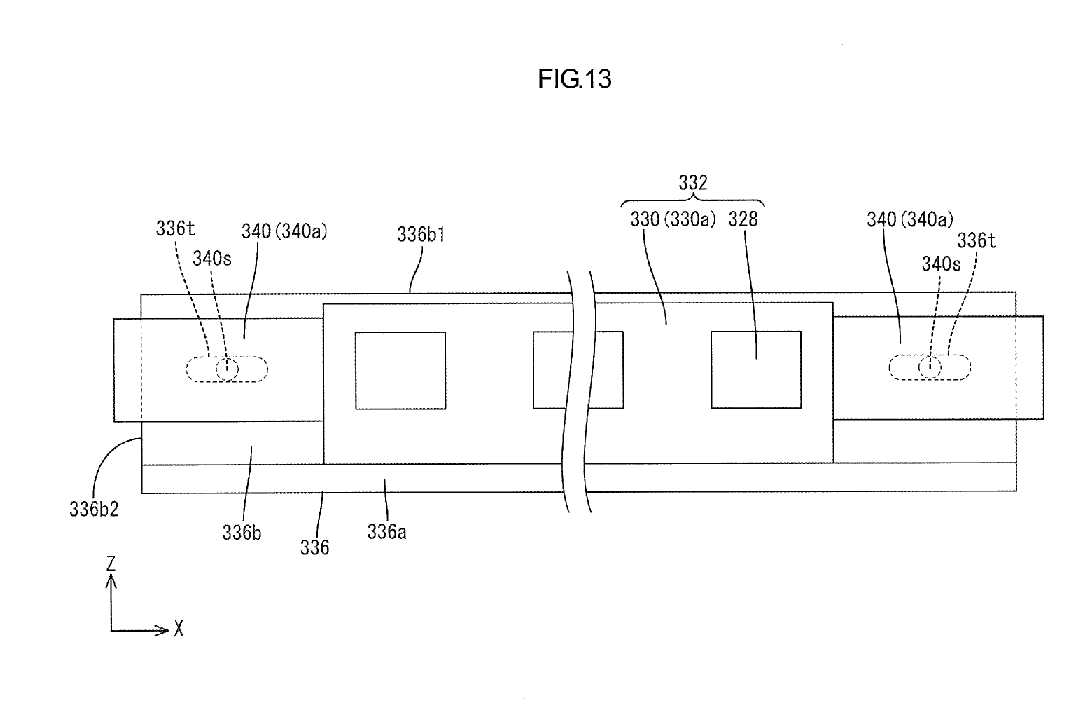

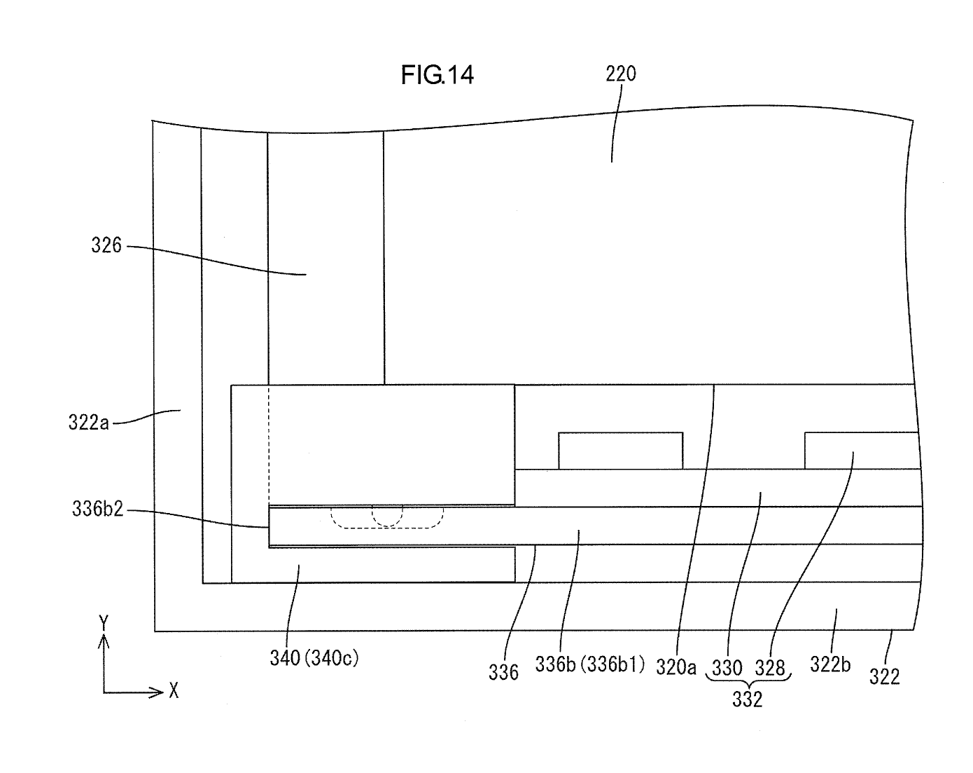

A modification of the third embodiment will be described with reference to the drawings. The third embodiment includes holding members 340 configured to hold a stand-up portion 336b differently from the third embodiment. Other configurations are the same as the third embodiment and thus configurations, functions, and effects of those will not be described. In FIG. 13, portions indicated by numerals including the reference numerals in FIG. 12 with 100 added thereto have the same configurations as the portions indicated by the respective reference numerals in the third embodiment. In FIG. 14, portions indicated by numerals including the reference numerals in FIG. 9 with 200 added thereto have the same configurations as the portions indicated by the respective reference numerals in the second embodiment.

In a liquid crystal display device according to the modification of the third embodiment, as illustrated in FIGS. 13 and 14, each holding member 240 is arranged in an outer portion. The holding member 240 holds the stand-up portion 336b from sides (from outer sides of side surfaces 336b2 of the stand-up portion 336b with respect to the longitudinal direction thereof (the X-axis direction)). Therefore, the upper wall of the restriction member 340 is in contact with the side surface 336b2 of the stand-up portion 336b with respect to the longitudinal direction thereof. A distal end surface of the first side wall 340a of the restriction member 340 on the LED board 330 side is in contact with the side surface of the LED board 340 on the short edge thereof. Configurations of engagement projections 340s and engagement holes 340t are the same as the third embodiment. Although holding configuration of the restriction members 340 is as such, movement of the restriction portions 340 in the minor-axis direction of the engagement hole 336t (the Z-axis direction) is still restricted. Similar to the third embodiment, the restriction members 350 are less likely to come off the stand-up portion 336. Therefore, proper optical properties can be maintained even when expansion or contract of the light guide plate 320 occurs.

### Fourth Embodiment

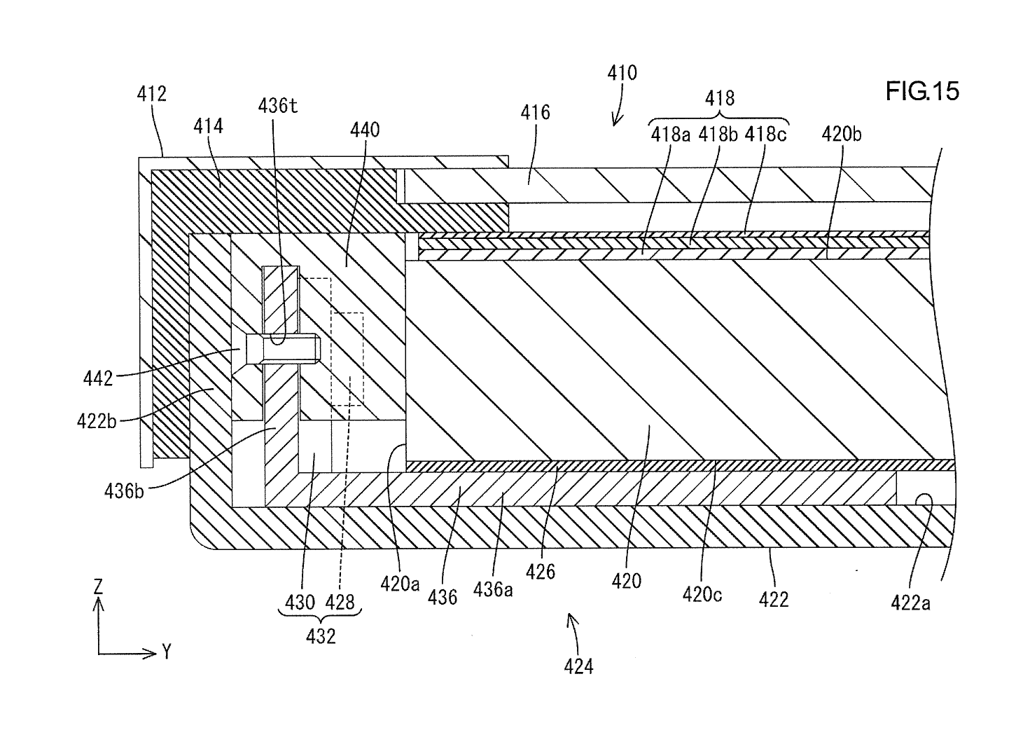

A fourth embodiment will be described with reference to the drawings. The fourth embodiment includes holding members 440 and screws 442 that are passed all the way through portions of the holding members 440. This configuration is different from the first embodiment. Other configurations are the same as the first embodiment and thus configurations, functions, and effects of those will not be described. In FIG. 15, portions indicated by numerals including the reference numerals in FIG. 8 with 300 added thereto have the same configurations as the portions indicated by the respective reference numerals in the second embodiment.

In a liquid crystal display device 410 according to the fourth embodiment, as illustrated in FIG. 15, a heat dissipation member 436 includes through holes 436t in a stand-up portion 436b. Each through hole 436t extends through the plate and has an oval shape with a major axis along the longitudinal direction of the stand-up portion 436b (the X-axis direction). The screws 442 are passed through the restriction members 440 from the rear (a side of the second side wall on the side wall 422b side of a chassis 322). The screws 442 are passed through the second side wall of the restriction members and the through holes 436t. Tips of the screws 442 are stuck in portions of the first side wall. The screws 442 are passed all the way through portions of the restriction members 440 and passed through the through holes 436t of the stand-up portion. With this configuration, movement of each restriction member 440 in the minor-axis direction of the through hole 436t having the oval shape (the Z-axis direction) is restricted. A force may be exerted on the restriction members 440 when the light guide plate 440 expands or contracts and the light guide plate 440 moves in the thickness direction thereof (the Z-axis direction). Even so, the restriction members 440 are further less likely to move (position shifting is less likely to occur). Therefore, the restriction members 440 are further less likely to come off the stand-up portion 436b. Because each through hole 436t has the oval shape, movement of each restriction member in the major-axis direction of the through hole 436t (the X-axis direction) is allowed. In this embodiment, the restriction members 440 are less likely to come off the stand-up portion 436b. Furthermore, even when the light guide plate 420 expands or contracts, proper optical properties are maintained.

Modifications of the above embodiments will be listed below.

(1) In each of the above embodiments, the restriction members are made of rubber and formed in a block-like shape. However, the configuration and the shape of the restriction members are not limited.

(2) In each of the above embodiments, a pair of the restriction members is arranged between the light entrance surface and the stand-up portion of the heat dissipation member. However, the number of the restriction members arranged between the light entrance surface and the stand-up portion of the heat dissipation member is not limited.

(3) In each of the above embodiments, the LED unit is arranged on one of the sides of the light guide plate. However, the light guide plate may be configured such that multiple sides thereof are light entrance surfaces and LED units are arranged on the sides of the light entrance surfaces, respectively. In such a case, the restriction members may be arranged on each LED unit side.

(4) In each of the above embodiments, the liquid crystal display device including the liquid crystal panel as the display panel is used. However, the aspect of the present invention can be applied to display devices including other types of display panels.

(5) In each of the above embodiments, the television device including the tuner is used. However, the present invention can be applied to display devices without tuners.

The embodiments have been described in detail. However, the above embodiments are only some examples and do not limit the scope of the claimed invention. The technical scope of the claimed invention includes various modifications of the above embodiments.

The technical elements described in this specification and the drawings may be used independently or in combination to achieve the technical benefits. The combinations are not limited to those in original claims. With the technologies described in this specification and the drawings, multiple objects may be accomplished at the same time. However, the technical benefits can be achieved by accomplishing even only one of the objects.

### EXPLANATION OF SYMBOLS

TV: Television device, Ca, Cb: Cabinet, T: Tuner, S: Stand, 10, 110, 210, 410: Liquid crystal display device, 12, 112, 212, 412: Bezel, 14, 114, 214, 414: Frame, 16, 116, 216, 416: Liquid crystal panel, 18, 118, 218, 418: Optical member, 20, 120, 220, 420: Light guide plate, 20a, 120a, 220a, 420a: Light entrance surface, 22, 122, 222, 422: Chassis, 24, 124, 224, 424: Backlight unit, 26, 126, 226, 426: Reflection sheet, 28, 128, 228, 428: LED, 30, 130, 230, 330, 430: LED board, 32, 132, 232, 332, 432: LED unit, 36, 136, 236, 336, 436: Heat dissipation member, 36a, 136a, 236a, 336a, 436a: Bottom portion, 36b, 136b, 236b, 336b, 436b: Stand-up portion, 40, 140, 240, 340, 440: Restriction portion, 236t, 336t: Engagement hole, 240s, 340s: Engagement projection, 436t: Through hole, 442 Screw.

1. A lighting device comprising:
a light guide plate including at least one side surface configured as a light entrance surface and a plate surface configured as a light exit surface;
a light source arranged such that a light emitting side thereof is opposite the light entrance surface;
a light source board having a rectangular shape and arranged such that a plate surface thereof faces the light entrance surface with a longitudinal direction thereof parallel to a plate surface direction of the light guide plate, wherein the light source is disposed on the plate surface thereof;
a chassis including at least a bottom plate arranged opposite from the light exit surface of the light guide plate and holding at least the light guide plate, the light source, and the light source board therein;
a heat dissipation member having a heat dissipation property and including a bottom portion and a stand-up portion, the bottom portion having a plate-like shape arranged on the bottom plate so as to be parallel to the bottom plate, the stand-up portion having a rectangular plate-like shape, projecting from a portion of the bottom portion toward the light exit surface, wherein the light source board is mounted to a plate surface of the stand-up portion such that a longitudinal direction thereof and a longitudinal direction of the stand-up portion are parallel to each other and a dimension of the stand-up portion in the longitudinal direction is larger than a dimension of the light source board in the longitudinal direction; and
a restriction member having elasticity, arranged in space other than space between the light source and the light entrance surface, configured to be in contact with the plate surface of the stand-up portion on which the light source board is mounted and the light entrance surface to maintain a distance between the light source and the light guide plate, and having a portion that is in contact with a side surface of the light source board on a short-edge side.

2. The lighting device according to claim 1, wherein the portion of the restriction member is affixed to the side surface of the light source board on the short-edge side.

3. The lighting device according to claim 1, wherein the restriction member has a rectangular U-shaped cross section and is arranged to support the stand-up portion from front and back and to be movable in a direction along a plate surface direction of the light guide plate and perpendicular to an arrangement direction of the light source and the light guide plate.

4. The lighting device according to claim 3, wherein
the restriction member includes an engagement projection that projects from a portion opposite the plate surface of the stand-up portion toward the stand-up portion, and
the stand-up portion includes an engagement hole in a portion opposite the engagement projection, the engagement hole being configured to receive the engagement projection and having an oval shape with a major axis along the longitudinal direction of the stand-up portion.

5. The lighting device according to claim 3, further comprising a screw, wherein
the stand-up portion includes a through hole that extends from one plate surface to another and has an oval shape with a major axis along the longitudinal direction of the stand-up portion, and
the screw is passed through at least one of portions of the restriction member arranged on a front surface side and a back surface side of the stand-up portion and through the through hole.

6. The lighting device according to claim 1, wherein a distance between the light source and the light entrance surface is within a range from 0.3 mm to 0.5 mm.

7. The lighting device according to claim 1, wherein the restriction member includes a pair of restriction members arranged so as to be in contact with side surfaces of the light source board on short-edge sides, respectively.

8. A display device comprising:
a display panel configured to provide display using light from the lighting device according to claim 1.

9. The display device according to claim 8, wherein the display panel is a liquid crystal display panel including liquid crystals.

10. A television device comprising the display device according to claim 8.
